(19) United States
(12) Patent Application Publication
(10) Pub. No.: US 2022/0358490 A1
(43) Pub. Date: Nov. 10, 2022

(54) CRYPTOCURRENCY SWAP PROTOCOL PROVIDING PAYMENT FUNCTION BASED ON LIQUIDITY POOL OVER DIFFERENT BLOCKCHAIN NETWORKS

(71) Applicant: ARBAIM INC., Seoul (KR)

(72) Inventors: Ryan Hyungeu Seol, Seoul (KR); Changhee Jung, Seongnam-si (KR)

(21) Appl. No.: 17/534,911

(22) Filed: Nov. 24, 2021

(30) Foreign Application Priority Data
May 10, 2021 (KR) 10-2021-0059712

(51) Int. Cl. G06Q 20/36

(52) U.S. Cl. CPC G06Q 20/3678; G06Q 2220/00

(57) ABSTRACT

In accordance with an exemplary embodiment of the present invention, a method for providing a liquidity pool-based cryptocurrency transaction brokerage service, the method being performed by a processor executing instructions stored in a memory, includes a code providing step of providing payment codes for service supported cryptocurrencies to an account of a buyer in response to a purchase request of the buyer for a transaction target product registered by a seller, a payment confirmation step of confirming whether a payment stablecoin for which a payment cryptocurrency corresponding to the payment code selected by the buyer is exchanged through a payment liquidity pool is paid from the account of the buyer, a coin delivery step of delivering the payment stablecoin to an account of a service provider, and a cryptocurrency settlement step of delivering a settlement cryptocurrency for which a settlement stablecoin paid from the account of the service provider is exchanged through a settlement liquidity pool to an account of the seller.

### CROSS-REFERENCE TO RELATED APPLICATION

This application claims priority to Korean Patent Application No. 10-2021-0059712 filed on May 10, 2021, and all the benefits accruing therefrom under 35 U.S.C. § 119, the contents of which are incorporated by reference in their entirety.

### BACKGROUND

The present disclosure relates to a cryptocurrency swap protocol that provides a payment and settlement functions based on a liquidity pool over different blockchain networks.

Various cryptocurrencies using blockchain technology are being used in the market. According to the decentralized blockchain technology, various cryptocurrencies can be recognized as independent monetary value independent of a key currency controlled by each country's central bank.

Cryptocurrencies function not only as a store of value, but also as a means of transaction brokerage, and thus can be used as a medium for product transaction in reality. For example, in e-commerce, a buyer can pay for a product purchase price with the cryptocurrency, and a seller can also receive a settlement money for the product sales price with the cryptocurrency. The transactions through such a cryptocurrency can significantly shorten the payment time of a transaction price, unlike the conventional key currency.

A service provider in cryptocurrency e-commerce can specify one type of cryptocurrency for payment of the purchase price and settlement of the sales price. In this case, a user who wants to pay and settle the price in a cryptocurrency other than the type of cryptocurrency specified in the e-commerce service can perform currency exchange between cryptocurrencies.

However, if the service provider performs the currency exchange between cryptocurrencies directly, the risk of foreign exchange loss due to price fluctuations during currency exchange can be borne, and thus a technology to solve the foreign exchange loss risk of the service provider can be required.

### SUMMARY

The present disclosure provides an e-commerce operation method that allows price payment and settlement to be made in various types of cryptocurrencies even if a cryptocurrency e-commerce service provider does not directly perform the currency exchange between cryptocurrencies.

In accordance with an exemplary embodiment of the present invention, a method for providing a liquidity pool-based cryptocurrency transaction brokerage service, the method being performed by a processor executing instructions stored in a memory, includes a code providing step of providing payment codes for service supported cryptocurrencies to an account of a buyer in response to a purchase request of the buyer for a transaction target product registered by a seller, a payment confirmation step of confirming whether a payment stablecoin for which a payment cryptocurrency corresponding to the payment code selected by the buyer is exchanged through a payment liquidity pool is paid from the account of the buyer, a coin delivery step of delivering the payment stablecoin to an account of a service provider, and a cryptocurrency settlement step of delivering a settlement cryptocurrency for which a settlement stablecoin paid from the account of the service provider is exchanged through a settlement liquidity pool to an account of the seller.

In the exemplary embodiment, an exchange between the payment cryptocurrency and the payment stablecoin through the payment liquidity pool and an exchange between the settlement cryptocurrency and the settlement stablecoin through the settlement liquidity pool may be performed according to a currency exchange relation expression based on a currency exchange constant and an exchange rate.

In the exemplary embodiment, the exchange rate for each type of cryptocurrency for a stablecoin in the currency exchange relation expression may be determined by a demand for currency exchange for each type of cryptocurrency of the seller and the buyer.

In the exemplary embodiment, the exchange rate for each type of cryptocurrency for a stablecoin in the currency exchange relation expression may be determined by a supply of liquidity for each type of cryptocurrency of the liquidity provider.

In the exemplary embodiment, an amount of a liquidity provision reward paid to an account of the liquidity provider may be determined differently for each type of cryptocurrency.

In the exemplary embodiment, a first settlement reward paid to the liquidity provider when the settlement cryptocurrency is any one of the service supported cryptocurrencies may be greater than a second settlement reward paid to the liquidity provider when the settlement cryptocurrency is not one of the service supported cryptocurrencies.

In the exemplary embodiment, the liquidity provision reward may be paid with a reward stablecoin.

In the exemplary embodiment, the payment stablecoin and the settlement stablecoin may be the same type of stablecoin.

A server for providing a liquidity pool-based cryptocurrency transaction brokerage service according to another exemplary embodiment of the present disclosure includes the memory and the processor for performing the method for providing the liquidity pool-based cryptocurrency transaction brokerage service.

### BRIEF DESCRIPTION OF THE DRAWINGS

Exemplary embodiments can be understood in more detail from the following description taken in conjunction with the accompanying drawings, in which:

FIG. 1 is a diagram for describing a system for providing a liquidity pool-based cryptocurrency transaction brokerage service according to some embodiments;

FIG. 2 is a block diagram illustrating elements configuring a server for providing a liquidity pool-based cryptocurrency transaction brokerage service according to some embodiments;

FIG. 3 is a diagram for describing a process in which a buyer pays for a product price according to some embodiments;

FIG. 4 is a diagram for describing a process in which a seller receives a settlement money for a product price according to some embodiments;

FIG. 5 is a diagram for describing a detailed process of operating the system for providing the liquidity pool-based cryptocurrency transaction brokerage service according to some embodiments; and

FIG. 6 is a flowchart illustrating steps of configuring a method for providing a liquidity pool-based cryptocurrency transaction brokerage service according to some embodiments.

### DETAILED DESCRIPTION OF EMBODIMENTS

Hereinafter, embodiments of the present disclosure will be described in detail with reference to the drawings. The following description is only for embodying the embodiments, and is not intended to restrict or limit the scope of rights according to the present disclosure. The matters that a person of ordinary skill in the art related to the present disclosure can easily infer from the detailed description and embodiments of the invention should be construed as belonging to the scope of rights of the present disclosure.

The terms used in the present disclosure have been described as general terms widely used in the technical field related to the present disclosure, but the meaning of the terms used in the present disclosure can vary depending on the intention of a technician in the relevant field, the emergence of new technology, examination standards or precedents, and the like. Some terms can be freely selected by the applicant, and in this case, the meaning of the freely selected terms will be described in detail. Terms used in the present disclosure should be construed as meanings reflecting the overall context of the specification, not just dictionary meanings.

A term such as ‘configured with’ or ‘including’ as used in the present disclosure should not be construed as necessarily including all of the components or steps described in the specification, and a case in which some components or steps are not included and a case in which additional components or steps are further included should also be construed as cases intended from the term.

Terms including an ordinal number such as ‘first’ or ‘second’ used in the present disclosure can be used to describe various components or steps, but the components or steps should not be limited by the ordinal number. Terms containing the ordinal number should only be construed for the purpose of distinguishing one component or step from other components or steps.

Hereinafter, embodiments of the present disclosure will be described in detail with reference to the drawings. Detailed descriptions of the matters widely known to a person of ordinary skill in the art related to the present disclosure will be omitted.

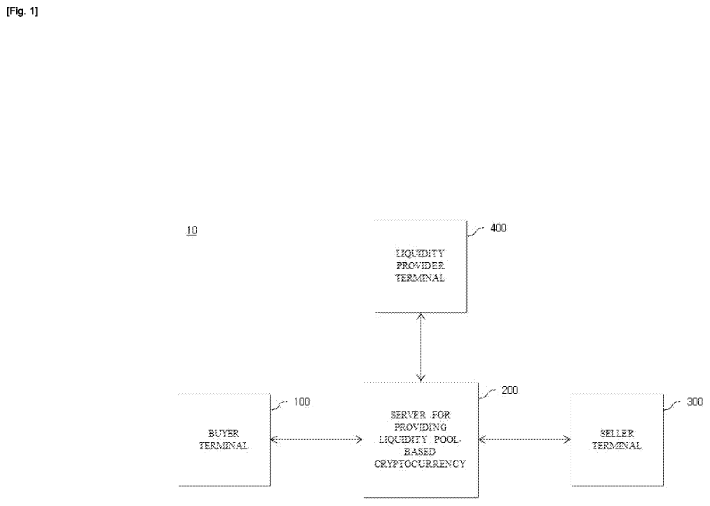

FIG. 1 is a diagram for describing a system for providing a liquidity pool-based cryptocurrency transaction brokerage service according to some embodiments.

Referring to FIG. 1, a system 10 for providing the liquidity pool-based cryptocurrency transaction brokerage service can be configured with a buyer terminal 100, a server 200, a seller terminal 300 and a liquidity provider terminal 400.

The liquidity pool-based cryptocurrency transaction brokerage service according to the system 10 can be implemented in a form of a computer program, a mobile application, or the like. The program or application implementing the system 10 can be executed in the buyer terminal 100, the server 200, the seller terminal 300, and the liquidity provider terminal 400.

The server 200 can provide the liquidity pool-based cryptocurrency transaction brokerage service through the program or application implementing the system 10, and the buyer terminal 100, the seller terminal 300, and the liquidity provider terminal 400 can be client terminals provided with a service by the server 200.

The buyer terminal 100, the seller terminal 300, and the liquidity provider terminal 400 may mean electronic devices such as PCs or smartphones used by the buyer, the seller, and the liquidity provider, respectively. The buyer, seller, and liquidity provider can access the service of the system 10 through their respective client terminal devices.

The liquidity pool-based cryptocurrency transaction brokerage service according to the system 10 may be an e-commerce service that allows the seller and the buyer to trade a transaction target product through a cryptocurrency. In the e-commerce service of the system 10, the transaction target product uploaded to the server 200 through the seller terminal 300 can be purchased through the buyer terminal 100.

In the process of the transaction target product being traded in the system 10, a liquidity pool can be provided by the liquidity provider terminal 400. The liquidity pool can provide money liquidity for exchanging a payment cryptocurrency, which is a type of cryptocurrency that the buyer intends to use, for a stablecoin, which is a type of cryptocurrency that the service provider operating the server 200 intends to receive.

Similarly, the liquidity pool may also provide money liquidity for exchanging the stablecoin paid by the service provider for a settlement cryptocurrency, which is the type of cryptocurrency that the seller intends to receive.

Delivery of cryptocurrencies such as the payment cryptocurrency, the stablecoin, and the settlement cryptocurrency in the system 10 can be performed by blockchain technology. When a money sender enters a payment code and payment amount to sign the transaction, a corresponding amount of cryptocurrency can be sent from a coin wallet of the sender to a coin wallet of a money recipient according to the payment code, and the transaction can be recorded in a contract according to a block chain technique to verify the sending and receiving of the cryptocurrency.

In the system 10, a stablecoin may mean a type of cryptocurrency designated by the service provider operating the server 200. The exchange of the stablecoin to payment/settlement cryptocurrencies can also be verified by recording a secure delivery process through the blockchain bridge and wallet.

When the service provider operates the system 10 and directly exchanges the payment cryptocurrency of the buyer and the settlement cryptocurrency of the seller for the stablecoin, the service provider bears the risk of loss due to price fluctuations due to the difference between the payment time, currency exchange time, and settlement time, and thus the liquidity provider can intervene to avoid the burden of loss risk. The liquidity provider can provide the liquidity pool for exchange between cryptocurrencies on behalf of the service provider, and thus receive a liquidity provision reward in return for bearing the risk.

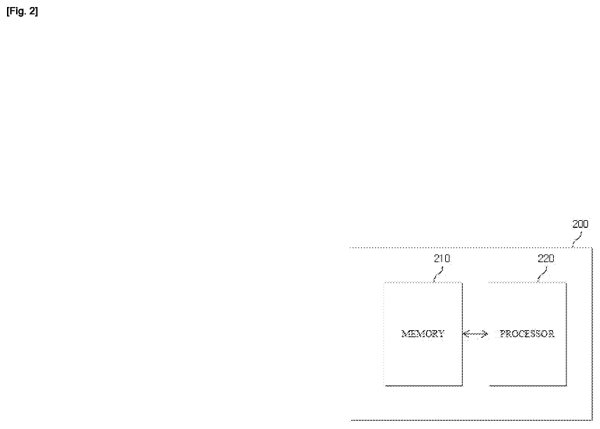

FIG. 2 is a block diagram illustrating elements configuring a server for providing a liquidity pool-based cryptocurrency transaction brokerage service according to some embodiments.

Referring to FIG. 2, the server 200 cany include a memory 210 and a processor 220. However, the present disclosure is not limited thereto, and other general-purpose elements may be further included in the server 200.

The server 200 may be a computing device for providing a transaction brokerage service according to the system 10. The server 200 can be implemented in a form of a PC, a workstation, a data center server, a cloud server, or a hybrid server. Alternatively, the server 200 can be implemented in a form of various electronic devices having processing performance, such as in a form of a mobile device such as a smart phone or a tablet PC.

The server 200 can include the memory 210 as a means for storing various data, instructions, at least one program or software, and can include the processor 220 as a means for performing processing on various data by executing instructions or at least one program.

The memory 210 can store various instructions for providing the transaction brokerage service according to the system 10. For example, the memory 210 can store instructions configuring software such as a computer program or mobile/web application, and can store various data necessary for the execution of the application or program.

The memory 210 can be implemented as a non-volatile memory such as a ROM, PROM, EPROM, EEPROM, flash memory, PRAM, MRAM, RRAM, FRAM, and the like, or can be implemented as a volatile memory such as a DRAM, SRAM, SDRAM, PRAM, RRAM, or FeRAM, and the like. Alternately, the memory 210 can be implemented as an HDD, SSD, SD, Micro-SD, and the like.

The processor 220 can perform a series of processing processes for providing the transaction brokerage service according to the system 10 by executing instructions stored in the memory 210. In addition, the processor 220 can perform an overall function for controlling the server 200, and may process various operations inside the server 200.

The processor 220 may be implemented with an array of multiple logic gates or a general-purpose microprocessor. The processor 220 may be configured with a single processor or a plurality of processors. The processor 220 may be integrally configured with the memory 210, rather than as a separate configuration from the memory 210 for storing instructions. For example, the processor 220 can be implemented in a form of at least one of a CPU, a GPU, and an AP provided in the server 200.

The processor 220, by executing the instructions stored in the memory 210, can perform a code providing step of providing payment codes for service supported cryptocurrencies to the account of the buyer in response to the purchase request of the buyer for the transaction target product registered by the seller.

The service supported cryptocurrencies may mean types of cryptocurrencies that support product payment except for the stablecoin in the system 10. Since the service supported cryptocurrencies are supported, the buyer can pay for the transaction target product even if the buyer does not have the stablecoin.

When there is a purchase request from the buyer, the payment codes that respectively correspond to the service supported cryptocurrencies are transmitted to the buyer, so that the buyer can be given a choice of which cryptocurrency to pay with. The payment code may contain information on the type of service supported cryptocurrency and the payment price.

The processor 220, by executing instructions stored in the memory 210, can perform a payment confirmation step of confirming whether the payment stablecoin for which the payment cryptocurrency corresponding to the payment code selected by the buyer is exchanged through the payment liquidity pool is paid from the account of the buyer, and can perform a coin delivery step of delivering the payment stablecoin to an account of the service provider.

The buyer can select C₃, which corresponds to the service supported cryptocurrencies (for example: C₁, C₂, and C₃), among the cryptocurrencies (for example: C₂, C₃, C₄) that the buyer have, as the payment cryptocurrency, and pay the purchase price of the transaction target product through the payment code corresponding to C₃. For the paid C₃, the liquidity provider can provide a settlement liquidity pool to exchange C₃ for a stablecoin corresponding to the purchase price, that is, a settlement stablecoin. The exchanged payment stablecoin can be delivered to the service provider.

The processor 220, by executing instructions stored in the memory 210, can perform a cryptocurrency settlement step of delivering a settlement cryptocurrency for which the settlement stablecoin paid from the account of the service provider is exchanged through a settlement liquidity pool to the account of the seller.

The service provider can transmit the settlement stablecoin, which means the stablecoin corresponding to the sales price, to the seller. For the settlement stablecoin, the liquidity provider can provide the settlement liquidity pools to exchange the settlement stablecoin for the settlement cryptocurrency. The settlement cryptocurrency may mean the type of cryptocurrency that the seller wishes to receive. Meanwhile, the settlement liquidity pool and the settlement liquidity pool may be provided by the same liquidity provider, or may be provided by different providers.

The liquidity provider(s) provides the payment liquidity pool or the settlement liquidity pool to exchange the stablecoin for the payment cryptocurrency or settlement cryptocurrency and bears the risk of exchange loss on behalf of the service provider, and thus a liquidity provision reward may be paid to the liquidity provider(s) in return for the burden of foreign exchange loss risk.

The liquidity provision reward can be paid with a reward stablecoin. The service provider can use the stablecoins for all of the purchase price received from the buyer, the sales price paid to the seller, and the reward paid to the liquidity provider. In addition, the payment stablecoin and the settlement stablecoin may be the same type of stablecoin. Meanwhile, the service provider can set the amount of reward differently for each cryptocurrency for which the stablecoin is exchanged through the liquidity pool.

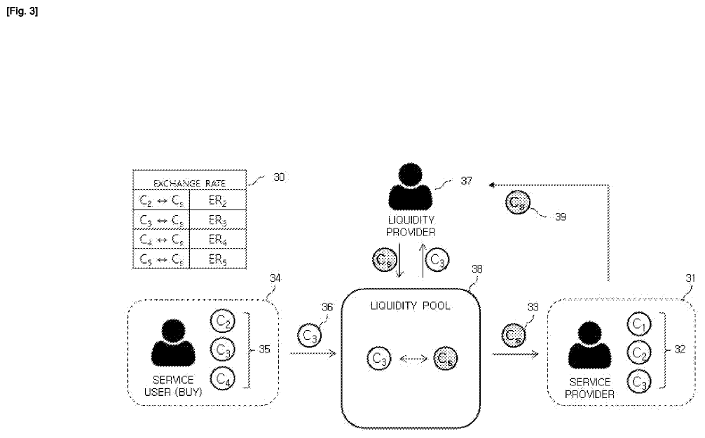

FIG. 3 is a diagram for describing a process in which the buyer pays for the product price according to some embodiments.

Referring to FIG. 3, a money flow between a service provider 31, a buyer 34, and a liquidity provider 37 in the system 10 is illustrated. Service supported cryptocurrencies 32 set by the service provider 31 may be C₁, C₂, and C₃, and currencies 35 that the buyer 34 has may be C₂, C₃, and C₄.

When the service provider 31 transmits three payment codes for C₁, C₂, and C₃ to the buyer 34 in response to a purchase request, the buyer 34 can select C₃ as a payment method and pay the purchase price with a payment cryptocurrency 36.

For the settlement cryptocurrency 36, the liquidity provider 37 can provide a settlement liquidity pool 38 to exchange C₃ for a stablecoin C. The exchanged payment stablecoin 33 can be delivered to the service provider 31. A exchange rate table 30 can represent an exchange rate between C₂, C₃, and C₄, which are the currencies 35 that the buyer 34 has, and the stablecoin C.

An exchange between the payment cryptocurrency 36 and the payment stablecoin 33 through the payment liquidity pool and an exchange between the settlement cryptocurrency and the settlement stablecoin through the settlement liquidity pool can be performed according to a currency exchange relation expression based on a currency exchange constant and an exchange rate.

For example, if a value of an exchange constant k is fixed at approximately 6,000, the exchange rate between a cryptocurrency A and a stablecoin fluctuates according to a change in value, and approximately 20 stablecoins can be exchanged for approximately 300 cryptocurrencies A, and such an exchange rate of 300:20 fluctuates, currency exchange can be performed at various exchange rates such as 600:10, 200:30, 150:40, and the like.

The buyer 34 can select any one of C₂ and C₃ of the currencies 35, that the buyer 34 has, as the payment cryptocurrency 36 based on exchange rate information of the exchange rate table 30. The buyer 34 can determine, in the exchange rate table 30, which of an exchange rate ER₂ of C₂ and an exchange rate ER₃ of C₃ is more advantageous for the currency exchange of the same amount of stablecoins.

In the currency exchange relation expression, the exchange rate for each type of cryptocurrency for stablecoins can be determined by i) the demand for currency exchange for each type of cryptocurrency from the seller and the buyer, and ii) the supply of liquidity for each type of cryptocurrency from the liquidity provider. That is, based on the stablecoin, the exchange rate for each type of cryptocurrency can be determined according to the market principle depending on a level of demand for each type of cryptocurrency from the seller and the buyer and a level of supply for each type of cryptocurrency by the liquidity provider.

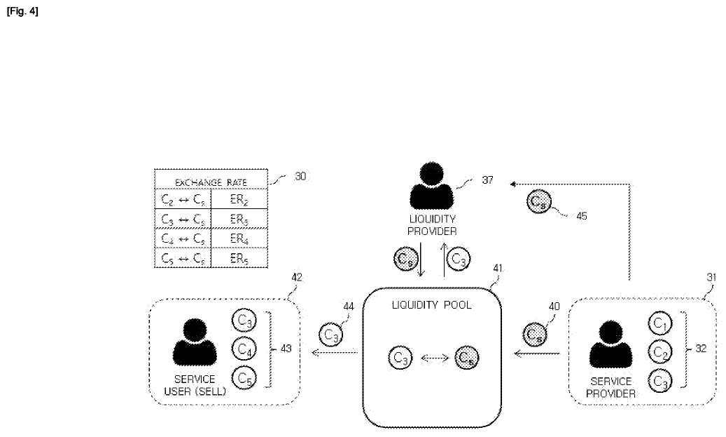

FIG. 4 is a diagram for describing a process in which the seller receives a settlement money for the product price according to some embodiments.

Referring to FIG. 4, the seller 42 may have C₃, C₄, and C₅ as currencies 43 that the seller 42 has. The service provider 31 may pay the sales price to the seller 42 with the settlement stablecoin 40 rather than the currencies 43 that the seller 42 has.

The seller 42 can exchange the settlement stablecoin 40 for the settlement cryptocurrency 44 through the settlement liquidity pool 41. In this case, the seller 42 can determine which cryptocurrency, for which the settlement stablecoin 40 is to be exchanged, among C₃, C₄, and C₅ of the currencies 43 that the seller 42 has. The exchange rate table 30 may be considered in determining the type of settlement cryptocurrency 44.

The service provider 31 may wish that the settlement cryptocurrency 44 exchanged by the seller 42 be any one of C₁, C₂, and C₃ so as to maintain a high monetary value of the service supported cryptocurrencies 32. To this end, the service provider 31 may set the liquidity provision reward for C₁, C₂, and C₃ higher than the liquidity provision reward for other cryptocurrencies than C₁, C₂, and C₃. That is, the amount of the liquidity provision reward paid to the account of the liquidity provider can be determined differently for each type of cryptocurrency.

Specifically, a first settlement reward paid to the account of the liquidity provider 37 when the settlement cryptocurrency 44 is any one of the service supported cryptocurrencies 32 can be greater than a second settlement reward paid to the account of the liquidity provider 37 when the settlement cryptocurrency 44 is not one of the service supported cryptocurrencies 32.

According to this, for C₁, C₂, and C₃ of the service supported cryptocurrencies 32, the supply of liquidity increases, which may affect the exchange rates of the exchange rate table 30, and the seller 42 may be more advantageous in terms of exchange rate to be exchanged for C₃ rather than C₄, and C₅, among C₃, C₄, and C₅ of the currencies 43 that the seller 42 has.

Therefore, as intended by the service provider 31 through reward differential, the proportion of the seller 42 selecting C₃ as the settlement cryptocurrency 44 may increase. This can be understood to indirectly recommend settlement through the service supported cryptocurrencies 32 because, in the payment process for the buyer, the service supported cryptocurrencies 32 can be directly restricted to force their use, but in the settlement process for the seller, restrictions on the type of cryptocurrency are not possible.

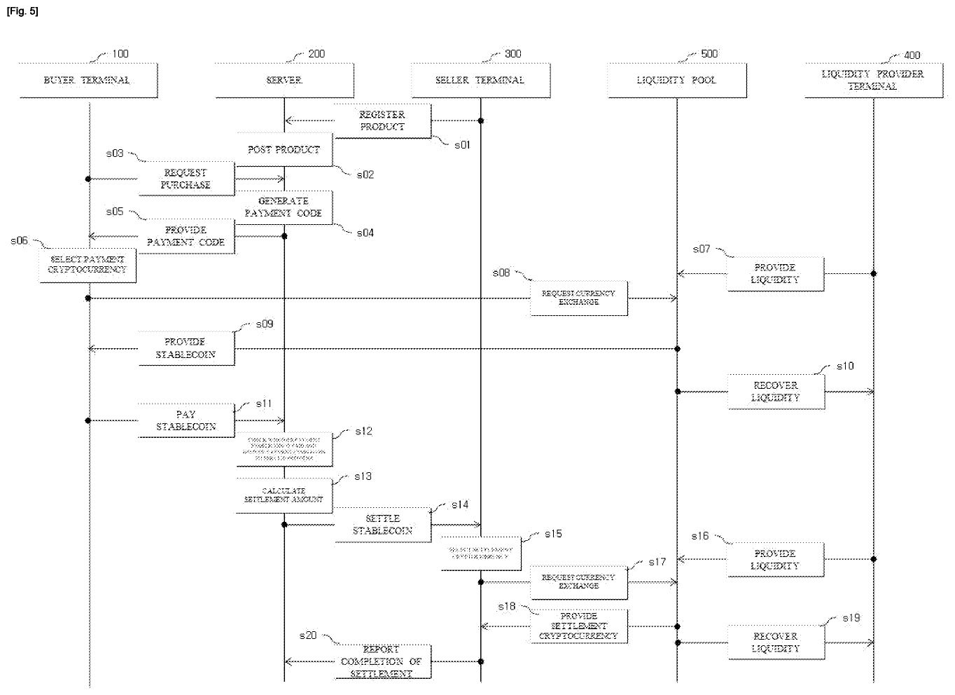

FIG. 5 is a diagram for describing a detailed process of operating the system for providing the liquidity pool-based cryptocurrency transaction brokerage service according to some embodiments.

Referring to FIG. 5, the steps performed by the buyer terminal 100 of the buyer, the server 200 of the service provider, the seller terminal 300 of the seller, and the liquidity provider terminal 400 of the liquidity provider in the system 10 are illustrated as steps s01 to s20, and a liquidity pool 500 involved in inter-coin currency exchange is illustrated. The liquidity pool 500 may be implemented through a server, and may be created automatically or by individual contract.

In step s01, the seller terminal 300 may register a sales target product in the server 200, and in step s02, the server 200 may post the sales target product on cryptocurrency e-commerce. In step s03, the buyer terminal 100 may transmit a purchase request for the posted product, and in step s04, the server 200 may generate payment codes for service supported cryptocurrencies in response thereto.

In step s05, the server 200 may transmit the payment codes, and in step s06, the buyer terminal 100 may select any one of the payment codes to select a payment cryptocurrency. In step s08, the buyer terminal 100 may request currency exchange, and in step s07 before step s08 is performed, the liquidity provider terminal 400 may provide liquidity for currency exchange to the liquidity pool 500.

In step s09, the stablecoin may be provided from the liquidity pool 500, and in step s10, the liquidity provider terminal 400 may recover the provided liquidity. In the process of providing and recovering liquidity, a certain percentage of fees may be paid as a reward to the liquidity provider. Alternatively, the reward may be paid through a separate procedure.

In FIG. 5, step s07 of providing liquidity is represented as being performed before step s08 of requesting currency exchange and step s10 of recovering liquidity is represented as being performed after step s09 of providing the stablecoin, but this is only an example.

That is, FIG. 5 only illustrates that step s07 of providing liquidity can be performed at least once before step s08 of requesting currency exchange and step s10 of recovering liquidity can be performed after the stablecoin is provided.

Therefore, the liquidity provider terminal 400 can provide liquidity to the liquidity pool 500 (s07) or recover liquidity from the liquidity pool 500 (s10) from time to time as needed, which may be performed independently of step s08 of requesting currency exchange and step s09 of providing the stablecoin. In step s11, the buyer terminal 100 can pay a payment stablecoin, and in step s12, the server 200 can check whether the payment stablecoin is paid from the buyer, deliver the paid payment stablecoin to the service provider, and in step s13, the server 200 can calculate the amount of settlement to be paid to the seller.

In step s14, the server 200 can pay a settlement stable coin, in step s15, the seller terminal 300 can select which settlement cryptocurrency for which the settlement stablecoin is exchanged, and in step s17, the seller terminal 300 may request currency exchange.

In step s16 before step s17 is performed, the liquidity provider terminal 400 can provide liquidity, and in step s18, the liquidity pool 500 can provide settlement cryptocurrency, and in step s19, the provided liquidity can be recovered again.

In step s20, the seller terminal 300 may report the completion of the settlement. As described above, a certain percentage of fees may be paid as a reward to the liquidity provider in the process of providing and recovering liquidity. Alternatively, the reward may be paid through a separate procedure.

Similarly, that is, FIG. 5 only illustrates that step s16 of providing liquidity can be performed if necessary before step s17 of requesting currency exchange and step s19 of recovering liquidity may proceed after the settlement cryptocurrency is provided.

Therefore, the liquidity provider terminal 400 may provide liquidity to the liquidity pool 500 (s16) or recover liquidity from the liquidity pool 500 (s19) from time to time as needed, which may be performed independently of step s17 of requesting currency exchange and step s18 of providing the settlement cryptocurrency.

In general, among steps s07, s10, s16, and s19, only steps s07 and s19 may be selectively performed and s10 and s16 may be omitted. However, if additional liquidity provision or recovery is required in the middle, all steps including s10 and s16 may be performed, and each step may be performed multiple times.

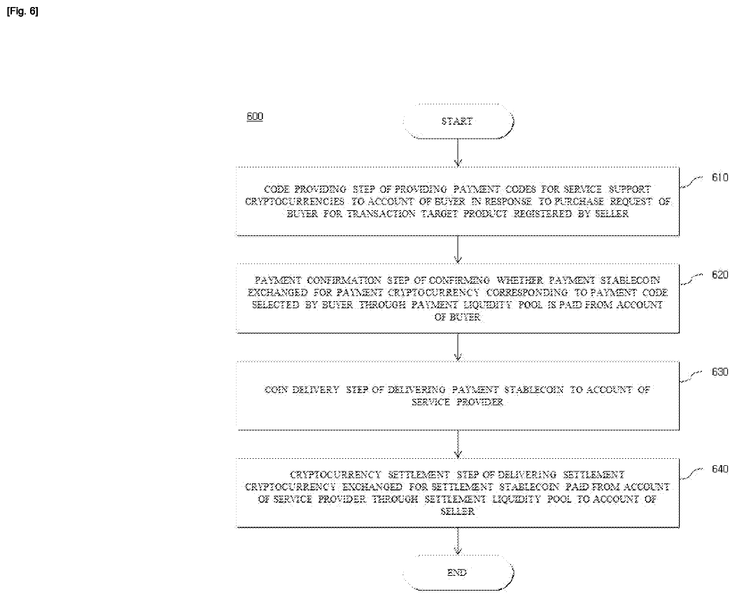

FIG. 6 is a flowchart illustrating steps of configuring a method for providing the liquidity pool-based cryptocurrency transaction brokerage service.

Referring to FIG. 6, a method 600 for providing the cryptocurrency transaction brokerage service can include a code providing step 610, a payment confirmation step 620, a coin delivery step 630, and a cryptocurrency settlement step 640. However, the present disclosure is not limited thereto, and other general-purpose steps may be further included in the method 600.

The method 600 can include steps processed in time series in the server 200 described above with reference to FIGS. 1 to 5. Accordingly, even if the contents are omitted below, the contents described above for the server 200 may also equally applied to the method 600.

In addition, the code providing step 610, the payment confirmation step 620, the coin delivery step 630 and the cryptocurrency settlement step 640 included in the method may mean summarizing steps s01 to s20 of FIG. 5 based on the server 200. Specifically, the code providing step 610 may correspond to steps s01 to s05 of FIG. 5, and the payment confirmation step 620 and the coin delivery step 630 may correspond to step s06 to step s12 of FIG. 5, and the cryptocurrency settlement step 640 may correspond to step s13 to step s20 of FIG. 5.

The method 600 can be performed by the processor 220 executing instructions stored in the memory 210.

The server 200 can perform the code providing step 610 of providing the payment codes for the service supported cryptocurrencies to the account of the buyer in response to the purchase request of the buyer for the transaction target product registered by the seller.

The server 200 can perform the payment confirmation step 620 of confirming whether the payment stablecoin for which the payment cryptocurrency corresponding to the payment code selected by the buyer is exchanged through the payment liquidity pool is paid from the account of the buyer.

The server 200 can perform the coin delivery step 630 of delivering the payment stablecoin to the account of the service provider.

The server 200 can perform the cryptocurrency settlement step 640 of delivering the settlement cryptocurrency for which the settlement stablecoin paid from the account of the service provider is exchanged through the settlement liquidity pool to the account of the seller.

Meanwhile, the method 600 may be recorded in a computer-readable recording medium in which at least one program or software including instructions for executing the method is recorded.

Examples of the computer-readable recording medium include magnetic media such as a hard disk, a floppy disk, and a magnetic tape, optical media such as a CD-ROM and a DVD, and magneto-optical media such as a floptical disk, and hardware devices specially configured to store and execute program instructions, such as ROM, RAM, flash memory, and the like. Examples of program instructions may include not only machine language codes such as those generated by a compiler, but also high-level language codes that can be executed by a computer using an interpreter or the like.

Although embodiments of the present disclosure have been described in detail above, the scope of rights according to the present disclosure is not limited thereto, and various modifications and improvements made thereto by those skilled in the art using the basic concept of the present disclosure set forth in the following claims also should be construed as being included in the scope of the rights according to the present disclosure.

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. Like reference numerals refer to like elements throughout. It will also be understood that when a layer, a film, a region or a plate is referred to as being ‘on’ another one, it can be directly on the other one, or one or more intervening layers, films, regions or plates may also be present. Further, it will be understood that when a layer, a film, a region or a plate is referred to as being ‘under’ another one, it can be directly under the other one, and one or more intervening layers, films, regions or plates may also be present. In addition, it will also be understood that when a layer, a film, a region or a plate is referred to as being ‘between’ two layers, films, regions or plates, it can be the only layer, film, region or plate between the two layers, films, regions or plates, or one or more intervening layers, films, regions or plates may also be present.

According to the server and method for providing the liquidity pool-based cryptocurrency transaction brokerage service according to the present disclosure, since a liquidity pool for the currency exchange of cryptocurrencies to stablecoins can be provided by the liquidity provider and accordingly a reward can be provided, even if a cryptocurrency e-commerce service provider does not directly perform the currency exchange, price payment and settlement can be performed with various types of cryptocurrencies, and thus the risk of foreign exchange loss of the service provider can be eliminated.

Although the cryptocurrency swap protocol that provides a payment function based on a liquidity pool over different blockchain networks has been described with reference to the specific embodiments, it is not limited thereto. Therefore, it will be readily understood by those skilled in the art that various modifications and changes can be made thereto without departing from the spirit and scope of the present invention defined by the appended claims.

1. A method for providing a liquidity pool-based cryptocurrency transaction brokerage service, the method being performed by a processor executing instructions stored in a memory, comprising:
a code providing step of providing payment codes for service supported cryptocurrencies to an account of a buyer in response to a purchase request of the buyer for a transaction target product registered by a seller;
a payment confirmation step of confirming whether a payment stablecoin for which a payment cryptocurrency corresponding to the payment code selected by the buyer is exchanged through a payment liquidity pool is paid from the account of the buyer;
a coin delivery step of delivering the payment stablecoin to an account of a service provider; and
a cryptocurrency settlement step of delivering a settlement cryptocurrency for which a settlement stablecoin paid from the account of the service provider is exchanged through a settlement liquidity pool to an account of the seller.

2. The method of claim 1, further comprising:
a step of providing, by a liquidity provider terminal, liquidity for currency exchange to the liquidity pool; and
a step of recovering, from the liquidity pool, the liquidity provided by the liquidity provider terminal again, wherein
in the process of providing and recovering liquidity, a certain percentage of a fee is paid as a reward to the liquidity provider.

3. The method of claim 2, wherein
an exchange between the payment cryptocurrency and the payment stablecoin through the payment liquidity pool and an exchange between the settlement cryptocurrency and the settlement stablecoin through the settlement liquidity pool are performed according to a currency exchange relation expression based on a currency exchange constant and an exchange rate.

4. The method of claim 3, wherein
the exchange rate for each type of cryptocurrency for a stablecoin in the currency exchange relation expression is determined by a demand for currency exchange for each type of cryptocurrency of the seller and the buyer.an

5. The method of claim 3, wherein
the exchange rate for each type of cryptocurrency for a stablecoin in the currency exchange relation expression is determined by a supply of liquidity for each type of cryptocurrency of the liquidity provider.

6. The method of claim 4, wherein
an amount of a liquidity provision reward paid to an account of the liquidity provider is determined differently for each type of cryptocurrency.

7. The method of claim 6, wherein
a first settlement reward paid to the liquidity provider when the settlement cryptocurrency is any one of the service supported cryptocurrencies is greater than a second settlement reward paid to the liquidity provider when the settlement cryptocurrency is not one of the service supported cryptocurrencies.

8. The method of claim 1, wherein
the liquidity provision reward is paid with a reward stablecoin.

9. The method of claim 1, wherein
the payment stablecoin and the settlement stablecoin are the same type of stablecoin.

10. A server for providing a liquidity pool-based cryptocurrency transaction brokerage service, comprising:
the memory for performing the method for providing the liquidity pool-based cryptocurrency transaction brokerage service according to claim 1; and
the processor for performing the method for providing the liquidity pool-based cryptocurrency transaction brokerage service according to claim 1.

11. The method of claim 5, wherein
an amount of a liquidity provision reward paid to an account of the liquidity provider is determined differently for each type of cryptocurrency.
